(19) United States
(12) Patent Application Publication
(10) Pub. No.: US 2020/0004697 A1
(43) Pub. Date: Jan. 2, 2020

(54) PATCHABLE HARDWARE FOR ACCESS CONTROL

(71) Applicant: QUALCOMM Incorporated, San Diego, CA (US)

(72) Inventors: Vincent Pierre LE ROY, San Diego, CA (US); Kevin Christopher GOTZE, Hillsboro, OR (US); David HARTLEY, Berlin (DE)

(21) Appl. No.: 16/024,596

(22) Filed: Jun. 29, 2018

(51) Int. Cl. G06F 12/14; G06F 21/79; G06F 21/76; G06F 21/62

(52) U.S. Cl. CPC G06F 12/1425; G06F 21/79; G06F 2221/2141; G06F 21/62; G06F 21/76

(57) ABSTRACT

In an aspect, an apparatus defines a group of registers that includes at least one of a plurality of registers in an integrated circuit. Each of the plurality of registers in the integrated circuit may be constrained to one of a plurality of fixed groups of registers. The apparatus applies a first set of access control rules to the group of registers, the first set of access control rules configured to override any of a second set of access control rules applied to the one or more fixed groups of registers.

### BACKGROUND

### Field of the Disclosure

Aspects of the disclosure relate generally to access control of resources in a device, and more specifically, but not exclusively, to a hardware patch for access control.

### Description of Related Art

Access control is implemented to provide trusted and secured mechanisms that protect resources, such as registers, in an integrated circuit (IC). Such trusted and secured mechanisms support security and stability of the overall system components by protecting the resources in the system belonging to various security stakeholders. For example, these stakeholders may include a manufacturer of the integrated circuit, an Original Equipment Manufacturer (OEM), a device owner, a carrier, a content provider, and/or a service provider. Often these stakeholders are proxied by hardware, firmware, or software entities on a system on chip (SOC), which are able to issue fabric transactions with security metadata. For example, the resources to be protected may include cryptographic material, software/firmware code, a device configuration, hardware accelerators, peripherals, etc. Therefore, access to registers and memory may need to be restricted to a subset of stakeholders by only permitting transactions with certain security metadata. Controlling access on a per-address basis would be impractical due to hardware issues (e.g., use of excessive silicon area and power consumption of the access control logic) and/or software issues (e.g., excessive programming time of the access control components and code size).

Resources, such as registers in an address-mapped device, are typically grouped in the hardware design of an integrated circuited based on their access control profile in order to create larger (but fewer) granules of the resources. For example, registers in an address-mapped device having the same transaction permissions (e.g., transaction permissions managed by the owner of the resources) may be grouped in the hardware design of an integrated circuited. For example, the transaction permissions may control transactions (e.g., read, write, reset, clear, execute, snoop and/or other suitable transactions) between an initiating device and a receiving device (also referred to as a target device). Access control with respect to such granules of resources may be programmed at software execution time. For example, a device coupled to an interconnect in an SOC may include any number of resource groups within it (e.g., as few as a single resource group or as many as hundreds of resource groups). In one example configuration, the mapping of addresses to a resource group may be fixed at design time and may not be aligned to a fixed granularity. In another example configuration, the mapping of addresses to a resource group may be fixed at design time and may be aligned to a fixed granularity (e.g. 4 KB). In yet another example configuration, the mapping of addresses to a resource group may be programmable.

However, assumptions made during the hardware design process for a device (e.g., an integrated circuit) regarding the access control profile for resources in the device might prove to be incorrect or no longer valid during the lifetime of the device. For example, a finer access control granularity may be needed to support unforeseen use cases, design oversights, and/or evolving threat models. For example, late in the validation cycle of a device, it may be determined that a group of registers sharing a single access control configuration contains some registers that must be shared with a specific entity and other registers that must not be shared with the specific entity. Since the grouping of the registers is fixed during the hardware design process, it is generally too late to modify the grouping of the registers when the need arises. Conventional approaches for mitigating these issues, which may include the relaxing of transaction permissions (e.g., possibly leading to weakened security) and/or rearchitecting software (e.g., proxy unauthorized accesses through an authorized entity that performs the access control in software), may be too expensive and inefficient.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In one aspect of the disclosure, a method is provided. The method defines a group of registers that includes at least one of a plurality of registers in an integrated circuit, wherein each of the plurality of registers in the integrated circuit has been constrained to one of a plurality of fixed groups of registers, and applies a first set of access control rules to the group of registers. The first set of access control rules are configured to override any of a second set of access control rules applied to the one or more fixed groups of registers.

In an aspect of the disclosure, an apparatus is provided. The apparatus includes a patch device that includes a processing circuit configured to define a group of registers that includes at least one of a plurality of registers in an integrated circuit, wherein each of the plurality of registers in the integrated circuit has been constrained to one of a plurality of fixed groups of registers. The processing circuit is further configured to apply a first set of access control rules to the group of registers, the first set of access control rules configured to override any of a second set of access control rules applied to the one or more fixed groups of registers.

In an aspect of the disclosure, an apparatus is provided. The apparatus includes means for defining a group of registers that includes at least one of a plurality of registers in an integrated circuit, wherein each of the plurality of registers in the integrated circuit has been constrained to one of a plurality of fixed groups of registers. The apparatus further includes means for applying a first set of access control rules to the group of registers, the first set of access control rules configured to override any of a second set of access control rules applied to the one or more fixed groups of registers.

In an aspect of the disclosure, a non-transitory processor-readable storage medium is provided. The non-transitory processor-readable storage medium has instructions stored thereon, which when executed by at least one processing circuit causes the at least one processing circuit to define a group of registers that includes at least one of a plurality of registers in an integrated circuit, wherein each of the plurality of registers in the integrated circuit has been constrained to one of a plurality of fixed groups of registers, and apply a first set of access control rules to the group of registers, the first set of access control rules configured to override any of a second set of access control rules applied to the one or more fixed groups of registers.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 illustrates an exemplary architecture including an integrated circuit that implements an access control device.

FIG. 2 illustrates an exemplary patch device in accordance with various aspects of the disclosure.

FIG. 3 illustrates an exemplary architecture implementing a patch device in accordance with various aspects of the disclosure.

FIG. 4 illustrates an exemplary architecture implementing a patch device in accordance with various aspects of the disclosure.

FIG. 5 is an illustration of an apparatus according to one or more aspects of the disclosure.

FIG. 6 illustrates a method operational in an apparatus that includes a patch device in accordance with various aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Access Control in an Integrated Circuit

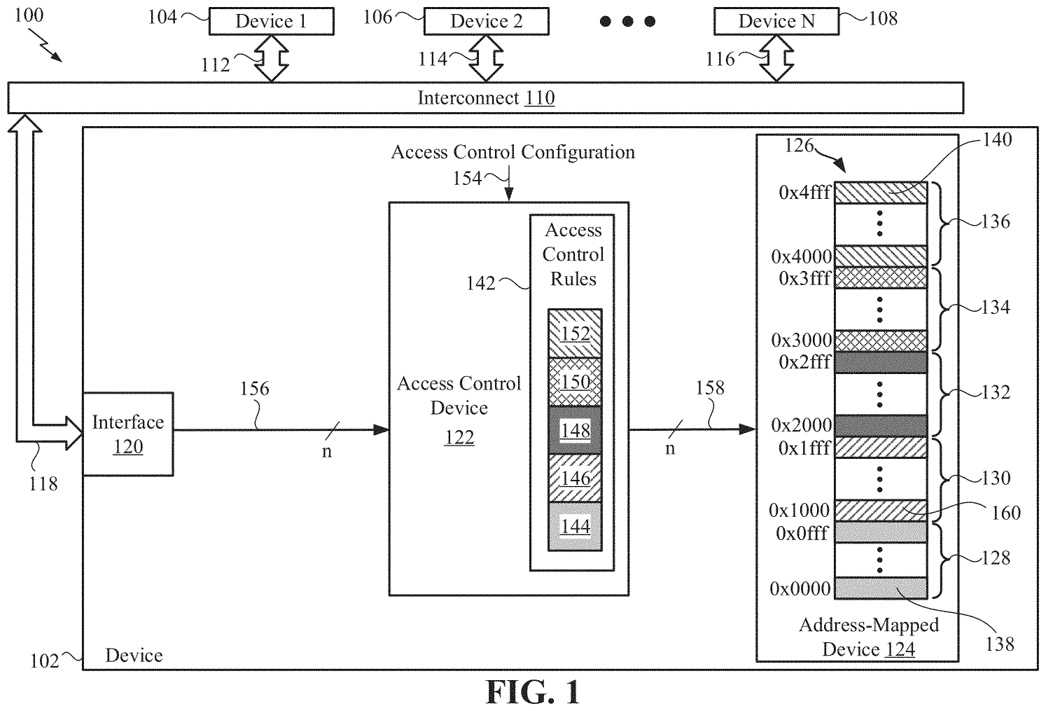

FIG. 1 illustrates an exemplary architecture 100. As shown in FIG. 1, the architecture 100 includes a device 102 and other devices that may be communicatively coupled to the device 102, such as the first device 104, the second device 106, and the Nth device 108. For example, the devices 102, 104, 106, and 108 may be any one of a central processing unit (CPU), a graphics processing unit (GPU), a modem, an integrated circuit configured for one or more functions (e.g., encoding/decoding video or audio), or other suitable device. As further shown in FIG. 1, each of the devices 102, 104, 106, and 108 may be coupled to the interconnect 110 via respective busses 118, 112, 114, and 116. Accordingly, the devices 102, 104, 106, and 108 in the architecture 100 may be configured to communicate with one another. For example, the interconnect 110 may be implemented as a network on chip (NOC), an on-chip interconnect fabric, a bus, or other suitable interconnect.

As shown in FIG. 1, the device 102 may include an interface 120, an access control device 122, and an address-mapped device 124. The interface 120 may be a bus interface circuit that includes a combination of circuits, counters, timers, control logic and/or other configurable circuits or hardware modules for enabling communication via the bus 118. For example, the address-mapped device 124 may include a set of registers 126 configured with an address range from 0x0000 to 0x4fff. For example, the register 138 may correspond to the address 0x0000 and the register 140 may correspond to the address 0x4fff. As shown in FIG. 1, each of the registers in the set of registers 126 may be constrained to a fixed group of registers. For example, the registers corresponding to the address range 0x0000 to 0x0fff may be in the first group of registers 128, the registers corresponding to the address range 0x1000 to 0xlfff may be in the second group of registers 130, the registers corresponding to the address range 0x2000 to 0x2fff may be in the third group of registers 132, the registers corresponding to the address range 0x3000 to 0x3fff may be in the fourth group of registers 134, and the registers corresponding to the address range 0x4000 to 0x4fff may be in the fifth group of registers 136.

The access control device 122 may implement access control rules 142 (also referred to as access control policies) for controlling access to the set of registers 126. Therefore, the access control device 122 may be considered to function as a hardware firewall. For example, the access control rules 142 may include a set of access control rules 144 for controlling access to the first group of registers 128, a set of access control rules 146 for controlling access to the second group of registers 130, a set of access control rules 148 for controlling access to the third group of registers 132, a set of access control rules 150 for controlling access to the fourth group of registers 134, and a set of access control rules 152 for controlling access to the fifth group of registers 136. It should be noted that each set of access control rules (e.g., the set of access control rules 144) in the access control device 122 and the corresponding group of registers (e.g., the first group of registers 128) in the set of registers 126 have the same shading.

In one example, the first device 104, the second device 106, and/or the Nth device 108 may attempt to access the address-mapped device 124. In this example, the set of access control rules 144 may be configured to allow the first device 104 access to the first group of registers 128 and to deny access to the remaining groups of registers (e.g., the second group of registers 130 to the fifth group of registers 136). The set of access control rules 146 may be configured to allow the second device 106 access to the second group of registers 130 and to deny access to the remaining groups of registers (e.g., the first group of registers 128 and the third group of registers 132 to the fifth group of registers 136). The set of access control rules 148 may be configured to allow the Nth device 108 access to the third group of registers 132 and to deny access to the remaining groups of registers (e.g., the first group of registers 128, the second group of registers 130, the fourth group of registers 134, and the fifth group of registers 136). Continuing with this example, if the first device 104 transmits a request to read the address-mapped device 124 of the device 102 via the bus 112, the device 102 may receive the request at the interface 120 via the bus 118. For example, the request may include an attribute (e.g., a secure identifier) of the requesting entity, an indication of a transaction (e.g., read, write, reset, clear, execute, snoop and/or other suitable transactions) with respect to the address-mapped device 124, and an address associated with the transaction. In other examples, the request may further include additional information, such as metadata.

The access control device 122 may receive the request from the interface 120 (e.g., as the n-bit signal 156) and may implement the access control rules 142 to determine whether the first device 104 should be permitted access to the address-mapped device 124. For example, the request (e.g., the n-bit signal 156) may include an attribute (e.g., a secure identifier) of the first device 104, information indicating a read transaction, and an address (e.g., 0x0fff) corresponding to a register within the address-mapped device 124. The access control device 122 may identify the address in the request (e.g., 0x0fff) and may determine a set of access control rules to be applied to the request based on that address. For example, if the address is 0x0fff as in the example above, the access control device 122 may determine that the address 0x0fff corresponds to a register within the first group of registers 128 and may determine that the set of access control rules 144 for controlling access to the first group of registers 128 should be applied to the request. For example, the set of access control rules 144 may include one or more attributes (e.g., one or more secure identifiers) of devices that are permitted to access the address-mapped device 124. In one configuration, each of the one or more attributes may correspond to one or more permitted transactions (e.g., read, write, reset, clear, execute, snoop and/or other suitable transactions). Therefore, if the access control device 122 determines that the attribute in the request matches to any of the one or more attributes in the set of access control rules 144 and further determines that the transaction in the request is permitted for that attribute, the access control device 122 may forward the request (e.g., the n-bit signal 158) to the address-mapped device 124.

The access control device 122 may be configured to modify the access control rules 142 based on an access control configuration command 154. For example, the access control configuration command 154 may modify any of the sets of access control rules (e.g., the sets of access control rules 144, 146, 148, 150, 152) implemented by the access control device 122. Such modification may include changing existing access control rules, deleting existing access control rules, and/or adding new access control rules. In the configuration of FIG. 1, it should be noted that the grouping of the registers in the set of registers 126 are fixed and may not be modified. For example, the first group of registers 128 may not be modified to include additional registers, such as the register 160 from the second group of registers 130. As another example, a register may not be removed from a group of registers. According to this example, the register 140 may not be removed from the fifth group of registers 136. Therefore, in the configuration of FIG. 1, the relationship between a set of access control rules (e.g., the set of access control rules 144) and a corresponding group of registers (e.g., the first group of registers 128) to which the set of access control rules are to be applied also remains fixed. As a result, the access control device 122 may not be configured to apply a set of access control rules to a new group of registers different from those shown in FIG. 1, which may limit the flexibility of the device 102 in some scenarios.

### Patch Device for Access Control

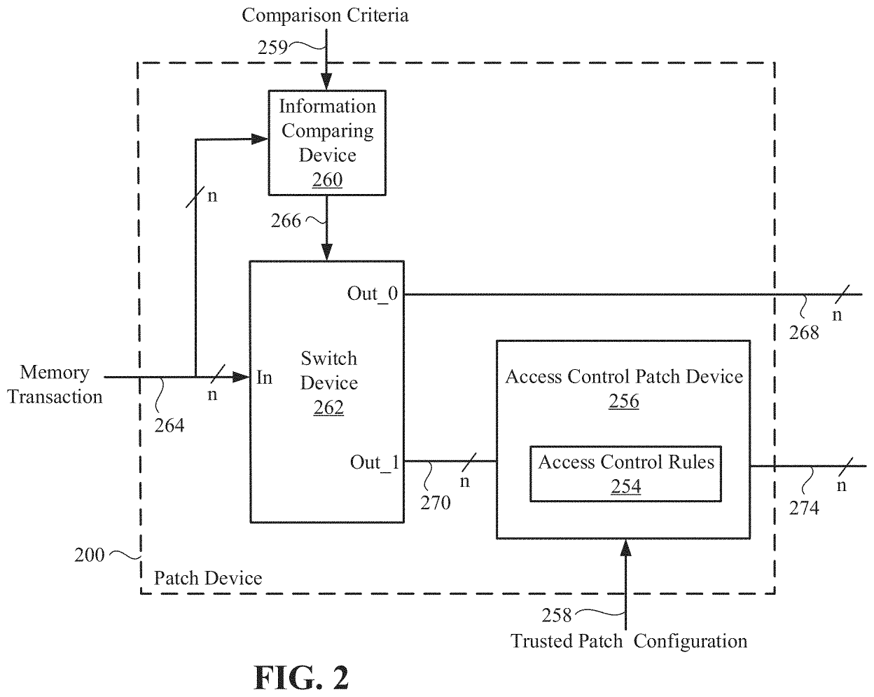

FIG. 2 illustrates an exemplary patch device 200 in accordance with various aspects of the disclosure. As shown in FIG. 2, the patch device 200 may include an access control patch device 256, an information comparing device 260, and a switch device 262. In some aspects of the disclosure, the access control patch device 256 may be configured to define a group of registers that includes one or more registers of an address-mapped device, where the registers of the address-mapped device are constrained to fixed groups. In some aspects of the disclosure, the access control patch device 256 may include access control rules 254 (also referred to as patched access control rules 254) that are to be applied to the group of registers defined by the access control patch device 256. In some aspects of the disclosure, the access control rules 254 may be configured to override any other access control rules that may be applied to each of the fixed groups of registers in the address-mapped device. In some aspects of the disclosure, the information comparing device 260 may include a set of criteria that may be compared to information in a transaction. In some aspects of the disclosure, the set of criteria may include a single address, a bit-mask address, a range of addresses, and/or one or more signals, characteristics, indicators associated with a transaction. In some aspects of the disclosure, addresses included in the set of criteria may or may not be aligned (e.g., consecutive). In some aspects of the disclosure, one or more portions of the patch device 200 (e.g., the information comparing device 260, the access control patch device 256, and/or the access control rules 254) may be programmed with software/firmware, including read-only memory (ROM) code in order to facilitate late changes in the hardware cycle. In other aspects, one or more portions of the patch device 200 may be programmed with hardware (e.g., through programmable ROM such as a fuse memory). In one aspect of the disclosure, the set of criteria may include one or more addresses corresponding to the group of registers defined by the access control patch device 256. For example, the information comparing device 260 may be configured to receive a signal 259 that includes the set of criteria (also referred to as comparison criteria). In some aspects of the disclosure, the set of criteria in the information comparing device 260 may be modified via the signal 259. In some aspects of the disclosure, the signal 259 may be received via in-band programming, which may include instructions and/or commands received through an NOC interface. In other aspects of the disclosure, the signal 259 may be received via out-of-band signaling, which may include instructions and/or commands received through a connection separate from an NOC interface.

In some aspects of the disclosure, the information comparing device 260 may control the switch device 262 with a signal 266. For example, the first output (e.g., Out_0) of the switch device 262 may be selected if the signal 266 includes a first value (e.g., ‘0’), and the second output (e.g., Out_1) may be selected if the signal 266 includes a second value (e.g., ‘1’).

As further shown in FIG. 2, the switch device 262 and the information comparing device 260 may receive a transaction (e.g., a memory transaction depicted as the n-bit signal 264). For example, the information comparing device 260 may compare an address in the memory transaction to the one or more addresses corresponding to the group of registers defined by the access control patch device 256. If the information comparing device 260 determines that the address in the memory transaction does not match at least one of the addresses corresponding to the group of registers defined by the access control patch device 256, the information comparing device 260 may select the first output (e.g., Out_0) of the switch device 262 to forward the memory transaction on the n-bit bus 268 (e.g., to a device coupled to the n-bit bus 268). If the information comparing device 260 determines that the address in the memory transaction matches at least one of the addresses corresponding to the group of registers defined by the access control patch device 256, the information comparing device 260 may select the second output (e.g., Out_1) of the switch device 262 to provide the memory transaction to the access control patch device 256 via the n-bit bus 270. In some aspects of the disclosure, the switch device 262 may include a buffer memory to momentarily store a transaction (e.g., the memory transaction depicted as the n-bit signal 264). The access control patch device 256 may then apply the access control rules 254 to the memory transaction. If the access control patch device 256 determines that the memory transaction should be allowed based on the access control rules 254, the access control patch device 256 may forward the memory transaction via the n-bit bus 274 (e.g., to the address-mapped device so that the memory transaction may be performed). If the access control patch device 256 determines that the memory transaction should be denied, the access control patch device 256 may not forward the memory transaction via the n-bit bus 274. In some aspects of the disclosure, the access control patch device 256 may be configured to define the group of registers based on information provided to the access control patch device 256, such as the trusted patch configuration information 258. In some aspects of the disclosure, the trusted patch configuration information 258 may provide and/or modify the access control rules 254.

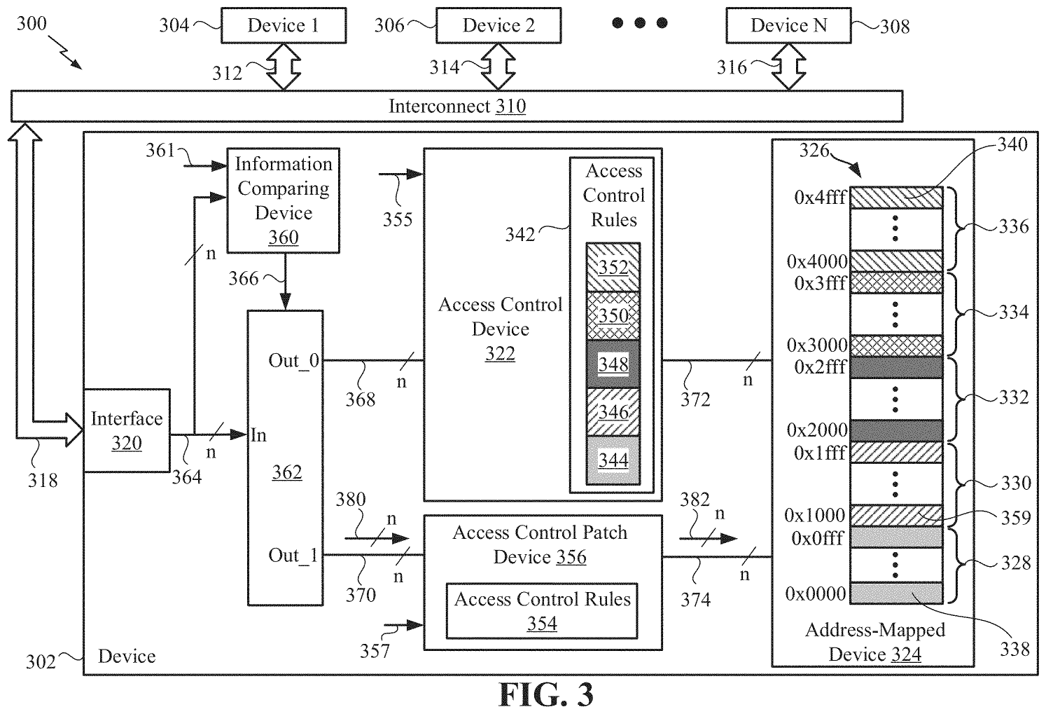

In some aspects of the disclosure, the patch device 200 may be implemented at receiving device (e.g., a device that receives a memory transaction) such as the device 302 in FIG. 3. In other aspects, the patch device 200 may be implemented at a transmitting device (e.g., a device that transmits a memory transaction) such as the first device 304 in FIG. 3. In some aspects, the patch device 200 may be implemented along a data path (e.g., bus) between a transmitting device and a receiving device.

In some aspects of the disclosure, to maintain security, one or a combination of the following rules may be enforced in the hardware of the patch device 200. For example, one or more portions of the patch device 200 may be programmed and/or may overwrite a group of resources (e.g., registers in an address-mapped device) if the patch device 200 is programmed by an immutable and auditable function (e.g. hardware and/or ROM code) or by the owner of the group of resources. For example, the patch device 200 may be locked (e.g. using a set-only register) to prevent further modification after start-up. For example, the patch device 200 (including a lock applied to the patch device 200) may be cleared (e.g. based on a locked register bit) if the underlying group of resources is released by its owner. For example, patch devices in addition to the patch device 200 may not be applied to a given transaction. If multiple patch devices are implemented, one of the patches may be applied based on a priority assigned to the patch devices. For example, a configuration of the patch device 200 relevant to a specific group of resources may be readable and/or auditable by all relying parties (e.g., devices that may be in communication with a device that includes the patch device 200) to enable detection of abusive or malicious usage. In some aspects of the disclosure, the patch device 200 may not impact the ability to audit patches. In such aspects, for example, one or more sets of criteria included in the information comparing device 260 may be observed by one or more parties (e.g., one or more devices that may be in communication with a device that includes the patch device 200)

FIG. 3 illustrates an exemplary architecture 300 in accordance with various aspects of the disclosure. As shown in FIG. 3, the architecture 300 includes a device 302 and other devices that may be communicatively coupled to the device 302, such as the first device 304, the second device 306, and the Nth device 308. For example, the devices 302, 304, 306, and 308 may be any one of a CPU, a GPU, a modem device, an integrated circuit configured for one or more functions (e.g., encoding/decoding video or audio), or other suitable device. As further shown in FIG. 3, each of the devices 302, 304, 306, and 308 may be coupled to the interconnect 310 via respective busses 318, 312, 314, and 316. Accordingly, the devices 302, 304, 306, and 308 in the architecture 300 may be configured to communicate with one another. For example, the interconnect 310 may be implemented as an NOC, an on-chip interconnect fabric, a bus, or other suitable interconnect.

In some aspects of the disclosure, the device 302 may include an interface 320, an access control device 322, and an address-mapped device 324. In some aspects of the disclosure, the device 302 may further include a patch device, such as the patch device 200 previously described with respect to FIG. 2. In such aspects of the disclosure, as shown in FIG. 3, the device 302 may include an access control patch device 356, an information comparing device 360, and a switch device 362. For example, the access control patch device 356, the information comparing device 360, and the switch device 362 may respectively correspond to the access control patch device 256, the information comparing device 260, and the switch device 262 previously described with reference to FIG. 2. In one example implementation, the patch device included in FIG. 3 may be an independent component (e.g., a package or a self-contained device). For example, the access control patch device 356, the information comparing device 360, and the switch device 362 may be collectively formed in an independent component. Accordingly, in this example, such independent component may be coupled to at least the interface 320, access control device 322, and the address-mapped device 324. In another example implementation, the patch device included in FIG. 3 may be a subcomponent or subassembly of at least one of the devices included in the device 302.

In some aspects of the disclosure, the interface 320 may be a bus interface circuit that includes a combination of circuits, counters, timers, control logic and/or other configurable circuits or modules for enabling communication via the bus 318. For example, the address-mapped device 324 may be a circuit (e.g., a processing circuit such as a central processing unit) that includes a set of registers 326 configured with an address range from 0x0000 to 0x4fff. For example, the register 338 may correspond to the address 0x0000 and the register 340 may correspond to the address 0x4fff. For example, each of the registers in the set of registers 326 may be a hardware register configured to store one or more bits of information. As shown in FIG. 3, each of the registers in the set of registers 326 may be constrained to a fixed group of registers. For example, the registers corresponding to the address range 0x0000 to 0x0fff may be in the first group of registers 328, the registers corresponding to the address range 0x1000 to 0xlfff may be in the second group of registers 330, the registers corresponding to the address range 0x2000 to 0x2fff may be in the third group of registers 332, the registers corresponding to the address range 0x3000 to 0x3fff may be in the fourth group of registers 334, and the registers corresponding to the address range 0x4000 to 0x4fff may be in the fifth group of registers 336.

In some aspects of the disclosure, the access control device 322 may implement access control rules 342 (also referred to as access control policies) for controlling access to the set of registers 326. Therefore, the access control device 322 may be considered to function as a hardware firewall. For example, the access control rules 342 may include a set of access control rules 344 for controlling access to the first group of registers 328, a set of access control rules 346 for controlling access to the second group of registers 330, a set of access control rules 348 for controlling access to the third group of registers 332, a set of access control rules 350 for controlling access to the fourth group of registers 334, and a set of access control rules 352 for controlling access to the fifth group of registers 336. It should be noted that each set of access control rules (e.g., the set of access control rules 344) in the access control device 322 and the corresponding group of registers (e.g., the first group of registers 328) in the set of registers 326 have the same shading.

The access control device 322 may be configured to modify the access control rules 342 based on an access control configuration command 355. For example, the access control configuration command 355 may modify any of the sets of access control rules (e.g., the sets of access control rules 344, 346, 348, 350, 352) implemented by the access control device 322. Such modification may include changing existing access control rules, deleting existing access control rules, and/or adding new access control rules. In the configuration of FIG. 3, it should be noted that the grouping of the registers in the set of registers 326 are fixed and may not be modified. For example, the first group of registers 328 may not be modified to include additional registers, such as the register 359 from the second group of registers 330. As another example, a register may not be removed from a group of registers. According to this example, the register 340 may not be removed from the fifth group of registers 336. Therefore, in the configuration of FIG. 3, the relationship between a set of access control rules (e.g., the set of access control rules 344) and a corresponding group of registers (e.g., the first group of registers 328) to which the set of access control rules are to be applied also remains fixed. As a result, the access control device 322 may not be configured to apply a set of access control rules to a new group of registers different from those shown in FIG. 3.

In some aspects of the disclosure, the access control patch device 356 may be configured to define a new group of registers in the set of registers 326 with respect to the fixed groups of registers (e.g., the first group of registers 328 to the fifth group of registers 336). In some aspects of the disclosure, the access control patch device 356 may include access control rules 354 that are to be applied to the group of registers defined by the access control patch device 356. In some aspects of the disclosure, the access control rules 354 may be configured to override the access control rules 342 that may be applied to each of the fixed groups of registers in the set of registers 326. In some aspects of the disclosure, the access control patch device 356 may be configured to define the group of registers based on information provided to the access control patch device 356, such as the trusted patch configuration information 357. In some aspects of the disclosure, the trusted patch configuration information 357 may provide and/or modify the access control rules 354.

In some aspects of the disclosure, the information comparing device 360 may include one or more addresses that correspond to the group of registers defined by the access control patch device 356. For example, the information comparing device 360 may be configured to receive a signal 361 that includes a set of criteria (e.g., the one or more addresses that correspond to the group of registers defined by the access control patch device 356) that may be compared to information in a transaction. In some aspects of the disclosure, the set of criteria in the information comparing device 360 may be modified via the signal 361. In some aspects of the disclosure, the signal 361 may be received via in-band programming, which may include instructions and/or commands received through the interface 320. In other aspects of the disclosure, the signal 361 may be received via out-of-band signaling, which may include instructions and/or commands received through a connection separate from the interface 320. In some aspects of the disclosure, the information comparing device 360 may control the switch device 362 with a signal 366. For example, the first output (e.g., Out_0) of the switch device 362 may be selected if the signal 366 includes a first value (e.g., ‘0’), and the second output (e.g., Out_1) may be selected if the signal 366 includes a second value (e.g., ‘1’).

In one example, the first device 304 may attempt to access the address-mapped device 324. In this example, the set of access control rules 344 may be configured to allow the first device 304 access to the first group of registers 328 and to deny access to the remaining groups of registers (e.g., the second group of registers 330 to the fifth group of registers 336). The set of access control rules 346 may be configured to allow the second device 306 access to the second group of registers 330 and to deny access to the remaining groups of registers (e.g., the first group of registers 328 and the third group of registers 332 to the fifth group of registers 336). Continuing with this example, if the first device 304 transmits memory transaction signals (e.g., a request to read the address-mapped device 324 of the device 302) via the bus 312, the device 302 may receive the memory transaction signals at the interface 320 via the bus 318. For example, the request may include an attribute (e.g., a secure identifier) of the requesting entity, an indication of a transaction (e.g., read, write, reset, clear, execute, snoop and/or other suitable transactions) with respect to the address-mapped device 324, and an address associated with the transaction. In other examples, the request may further include additional information, such as metadata. In one scenario, the first device 304 may need to access (e.g., read) the register 359 in the second group of registers 330 and the register 340 in the fifth group of registers 336 in addition to accessing the registers in the first group of registers 328. In this scenario, the access control patch device 356 may be configured to form a new group of registers that includes the register 340 and the register 359, and to apply the same access control rules (e.g., the access control rules 354) to this new group of registers. For example, the access control rules 354 applied to the new group of registers may allow the first device 304 access to the new group of registers while denying access to other devices. In this scenario, the addresses corresponding to the registers in the new group of registers (e.g., the addresses corresponding to the register 340 and the register 359) may be provided to the information comparing device 360.

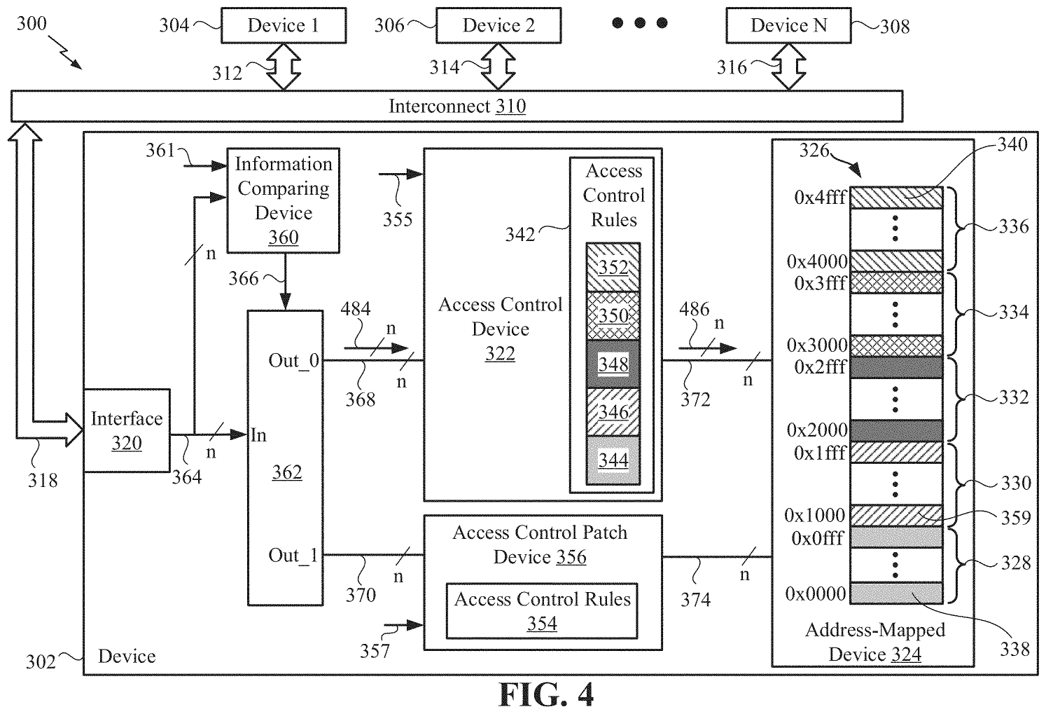

For example, the first device 304 may transmit to the device 302 a memory transaction requesting to read the register 359. The switch device 362 and the information comparing device 360 may receive the request (e.g., the n-bit signal 364), and the information comparing device 360 may compare the address in the request (e.g., the address x1000 of the register 359) to the addresses corresponding to the registers in the new group of registers (e.g., 0x1000 and 0x4fff). If the information comparing device 360 determines that the address in the request matches at least one of the addresses corresponding to the new group of registers, the information comparing device 360 may select the second output (e.g., Out_1) of the switch device 362 to provide the request (e.g., the n-bit signal 380) to the access control patch device 356 via the n-bit bus 370. In some aspects of the disclosure, the switch device 362 may include a buffer memory to momentarily store a transaction (e.g., the n-bit signal 364 representing a memory transaction in some of the aspects described herein). The access control patch device 356 may then apply the access control rules 354 to the request and if the access control patch device 356 determines that the request should be allowed based on the access control rules 354, the access control patch device 356 may forward the request (e.g., the n-bit signal 382) to the address-mapped device 324 via the n-bit bus 374. If the access control patch device 356 determines that the request should be denied, the access control patch device 356 may not forward the request via the n-bit bus 374. In an alternative scenario, with reference to FIG. 4, if the information comparing device 360 determines that the address in the request does not match at least one of the addresses corresponding to the new group of registers, the information comparing device 360 may select the first output (e.g., Out_0) of the switch device 362 provide the request (e.g., the n-bit signal 484) to the access control device 322 via the n-bit bus 368. The access control device 322 may then apply the access control rules 342 to the request and if the access control device 322 determines that the request should be allowed based on the access control rules 342, the access control device 322 may forward the request (e.g., the n-bit signal 486) to the address-mapped device 324 via the n-bit bus 372.

Therefore, the aspects of the patch device described herein (e.g., the patch device 200 in FIG. 2 and the example implementation of the patch device shown in FIGS. 3 and 4) may provide exceptions to the fixed groups of registers for purposes of access control in a device (e.g., an integrated circuit). Accordingly, the patch device described herein may provide flexibility to support unplanned access control profiles after the hardware design of the device is completed. The patch device described herein may have a low implementation cost (e.g., few programming registers per patch and few logical gates to encode the access control rules described herein). Moreover, the patch device may be implemented without introducing any significant degradation to the performance of a device.

Exemplary Apparatus and Method Thereon

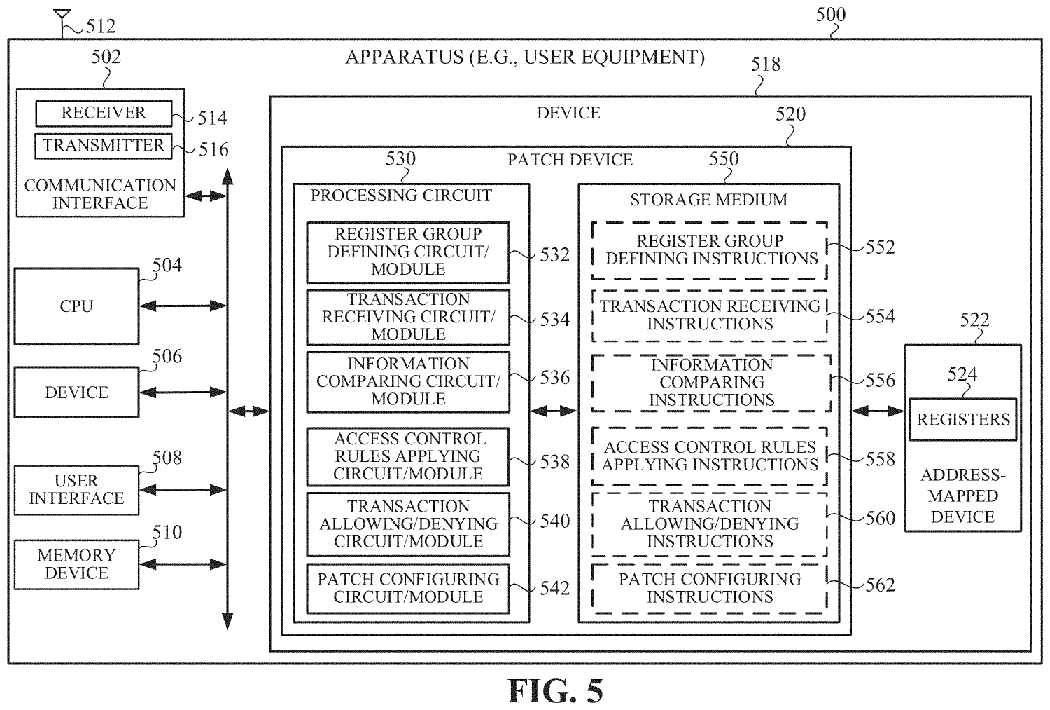

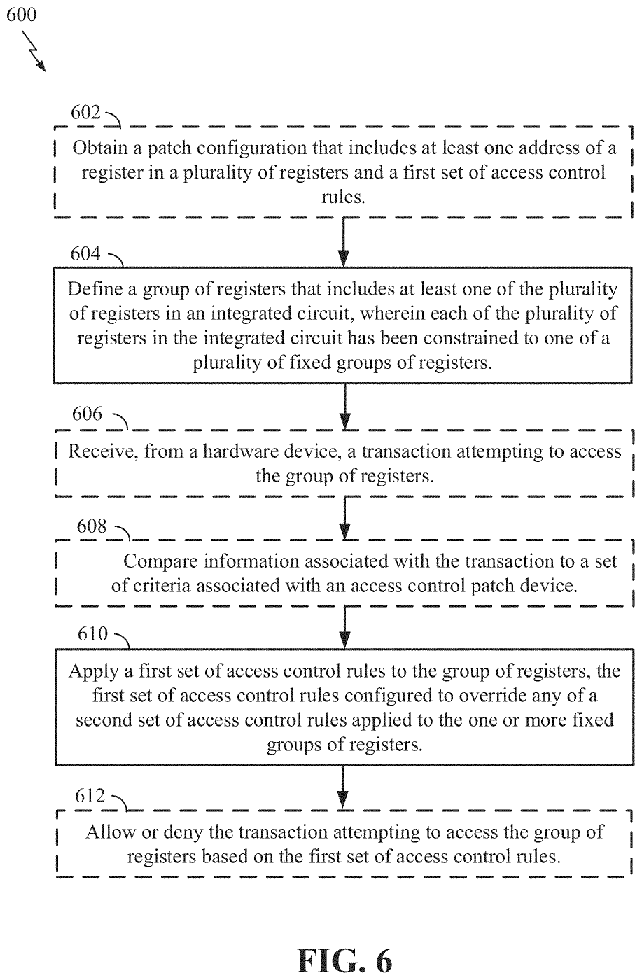

FIG. 5 is an illustration of an apparatus 500 according to one or more aspects of the disclosure (e.g., aspects related to the method of FIG. 6 described below). The apparatus 500 includes a communication interface (e.g., at least one transceiver) 502, a CPU 504, devices 506 and 518, a user interface 508, and a memory device 510. These components can be coupled to and/or placed in electrical communication with one another via a signaling bus or other suitable component, represented generally by the connection lines in FIG. 5. The signaling bus may include any number of interconnecting buses and bridges depending on the specific application of the CPU 504 and the overall design constraints. The signaling bus links together the communication interface 502, the CPU 504, the device 506, the user interface 508, the memory device 510, and the device 518. The signaling bus may also link various other circuits (not shown) such as timing sources, peripherals, voltage regulators, and power management circuits, which are well known in the art, and therefore, will not be described any further.

The communication interface 502 may be adapted to facilitate wireless communication of the apparatus 500. For example, the communication interface 502 may include circuitry and/or code (e.g., instructions) adapted to facilitate the communication of information bi-directionally with respect to one or more communication devices in a network. The communication interface 502 may be coupled to one or more antennas 512 for wireless communication within a wireless communication system. The communication interface 502 can be configured with one or more standalone receivers and/or transmitters, as well as one or more transceivers. In the illustrated example, the communication interface 502 includes a receiver 514 and a transmitter 516.

The memory device 510 may serve as a main memory for the CPU 504 of the apparatus 500. In some implementations, the memory device 510 is implemented as a common memory component. The storage medium 550 may represent one or more computer-readable, machine-readable, and/or processor-readable devices for storing code, such as processor executable code or instructions (e.g., software, firmware), electronic data, databases, or other digital information. For example, the storage medium 550 may be used for storing data that is manipulated by the processing circuit 530 of the patch device 520 when executing code. The storage medium 550 may be any available media that can be accessed by a general purpose or special purpose processor, including portable or fixed storage devices, optical storage devices, and various other mediums capable of storing, containing or carrying code.

By way of example and not limitation, the storage medium 550 may include, a random access memory (RAM), a static random access memory (SRAM), a dynamic random access memory (DRAM), a register, a configuration of one or more fuses, and/or any other suitable medium for storing code that may be accessed and read by a computer. The storage medium 550 may be embodied in an article of manufacture (e.g., a computer program product). By way of example, a computer program product may include a computer-readable medium in packaging materials. In view of the above, in some implementations, the storage medium 550 may be a non-transitory (e.g., tangible) storage medium. The storage medium 550 may be coupled to the processing circuit 530 of the patch device 520, such that the processing circuit 530 can read information from, and write information to, the storage medium 550.

Code and/or instructions stored by the storage medium 550, when executed by the processing circuit 530 of the patch device 520, causes the processing circuit 530 to perform one or more of the various functions and/or process operations described herein. For example, the storage medium 550 may include operations configured for regulating operations at one or more hardware blocks of the processing circuit 530.

The processing circuit 530 of the patch device 520 is generally adapted for processing, including the execution of such code/instructions stored on the storage medium 550. As used herein, the term “code” or “instructions” shall be construed broadly to include without limitation programming, instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 530 of the patch device 520 is arranged to obtain, process and/or send data, control data access and storage, issue commands, and control other desired operations. The processing circuit 530 may include circuitry configured to implement desired code provided by appropriate media in at least one example. For example, the processing circuit 530 may be implemented as one or more processors, one or more controllers, and/or other structure configured to execute executable code. Examples of the processing circuit 530 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 530 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 530 are for illustration and other suitable configurations within the scope of the disclosure are also contemplated.

According to one or more aspects of the disclosure, the processing circuit 530 may be adapted to perform any or all of the features, processes, functions, operations and/or routines for any or all of the apparatuses described herein. As used herein, the term “adapted” in relation to the processing circuit 530 may refer to the processing circuit 530 being one or more of configured, employed, implemented, and/or programmed to perform a particular process, function, operation and/or routine according to various features described herein.

According to at least one example of the apparatus 500, the processing circuit 530 may include one or more of a register group defining circuit/module 532, transaction receiving circuit/module 534, information comparing circuit/module 536, access control rules applying circuit/module 538, transaction allowing/denying circuit/module 540, and a patch configuring circuit/module 542 that are adapted to perform any or all of the features, processes, functions, operations and/or routines described herein (e.g., features, processes, functions, operations and/or routines described with respect to FIG. 6).

The register group defining circuit/module 532 may include circuitry and/or instructions (e.g., register group defining instructions 552 stored on the storage medium 550) adapted to perform several functions relating to, for example, defining a group of registers that includes at least one of a plurality of registers in an integrated circuit, wherein each of the plurality of registers in the integrated circuit has been constrained to one of a plurality of fixed groups of registers. For example, such plurality of registers may be the registers 524 of the address-mapped device 522 shown in FIG. 5. In some aspects of the disclosure, the address-mapped device 522 and the registers 524 in FIG. 5 may respectively correspond to the address-mapped device 324 and the set of registers 326 in FIGS. 3 and 4.

The transaction receiving circuit/module 534 may include circuitry and/or instructions (e.g., transaction receiving instructions 554 stored on the storage medium 550) adapted to perform several functions relating to, for example, receiving, from a hardware device, a transaction attempting to access the group of registers. The information comparing circuit/module 536 may include circuitry and/or instructions (e.g., information comparing instructions 556 stored on the storage medium 550) adapted to perform several functions relating to, for example, comparing information associated with a transaction to a set of criteria associated with an access control patch device. The access control rules applying circuit/module 538 may include circuitry and/or instructions (e.g., access control rules applying instructions 558 stored on the storage medium 550) adapted to perform several functions relating to, for example, applying a first set of access control rules to the group of registers. In some aspects of the disclosure, the first set of access control rules is configured to override any of a second set of access control rules applied to the one or more fixed groups of registers. The transaction allowing/denying circuit/module 540 may include circuitry and/or instructions (e.g., transaction allowing/denying instructions 560 stored on the storage medium 550) adapted to perform several functions relating to, for example, allowing or denying the transaction attempting to access the group of registers based on the first set of access control rules. The patch configuring circuit/module 542 may include circuitry and/or instructions (e.g., patch configuring instructions 562 stored on the storage medium 550) adapted to perform several functions relating to, for example, obtaining a patch configuration that includes at least one address of a register in the plurality of registers and the first set of access control rules.

As mentioned above, instructions stored by the storage medium 550, when executed by the processing circuit 530 of the patch device 520, causes the processing circuit 530 to perform one or more of the various functions and/or process operations described herein. For example, the storage medium 550 may include one or more of the register group defining instructions 552, transaction receiving instructions 554, information comparing instructions 556, access control rules applying instructions 558, transaction allowing/denying instructions 560, and patch configuring instructions 562.

FIG. 6 illustrates a method 600 operational in an apparatus that includes a patch device (e.g., the patch device 200, 520) in accordance with various aspects of the present disclosure. It should be understood that the operations indicated with dashed lines in FIG. 6 represent optional operations. In an aspect of the disclosure, the patch device obtains a patch configuration that includes at least one address of a register in a plurality of registers and a first set of access control rules 602. The patch device defines a group of registers that includes at least one of a plurality of registers in an integrated circuit, wherein each of the plurality of registers in the integrated circuit has been constrained to one of a plurality of fixed groups of registers 604. In an aspect, the group of registers is defined based on the at least one address in the patch configuration. The patch device receives, from a hardware device (e.g., the device 304, 506), a transaction attempting to access the group of registers 606. The patch device compares information associated with the transaction to a set of criteria associated with an access control patch device 608. In an aspect, the information associated with the transaction includes at least one address that corresponds to one of the plurality of registers and the set of criteria includes one or more addresses that correspond to registers in the group of registers. The patch device applies the first set of access control rules (e.g., the access control rules 354 in FIGS. 3 and 4) to the group of registers, the first set of access control rules configured to override any of a second set of access control rules (e.g., the access control rules 342 in FIGS. 3 and 4) applied to the one or more fixed groups of registers 610. In an aspect, the patch device applies the first set of access control rules to the group of registers when at least some of the information associated with the transaction matches the set of criteria. In an aspect, the first set of access control rules includes an attribute of at least one hardware device that is permitted to access the group of registers. For example, the attribute may include a secure identifier of the at least one hardware device. For example, the at least one hardware device may be the first device 304, the second device 306, and/or the Nth device 308 shown in FIGS. 3 and 4, or the device 506 shown in FIG. 5. In an aspect, the information associated with the transaction includes an attribute of the hardware device that initiated the transaction. In an aspect, at least one of the first set of access control rules applied to the group of registers is different from the second set of access control rules applied to the one or more fixed groups of registers. The patch device allows or denies the transaction attempting to access the group of registers based on the first set of access control rules 612.

Those of skill in the art would further appreciate that the various illustrative logical blocks, modules, circuits, and algorithm steps described in connection with the implementations disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

Within the disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the disclosure, without limitation as to the type of electronic circuits, as well as software implementations of information and instructions that, when executed by a processor, enable the performance of the functions described in the disclosure.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

Accordingly, the various features associate with the examples described herein and shown in the accompanying drawings can be implemented in different examples and implementations without departing from the scope of the disclosure. Therefore, although certain specific constructions and arrangements have been described and shown in the accompanying drawings, such implementations are merely illustrative and not restrictive of the scope of the disclosure, since various other additions and modifications to, and deletions from, the described implementations will be apparent to one of ordinary skill in the art. Thus, the scope of the disclosure is only determined by the literal language, and legal equivalents, of the claims which follow.

What is claimed is:

1. A method comprising:
defining a group of registers that includes at least one of a plurality of registers in an integrated circuit, wherein each of the plurality of registers in the integrated circuit has been constrained to one of a plurality of fixed groups of registers; and
applying a first set of access control rules to the group of registers, the first set of access control rules configured to override any of a second set of access control rules applied to the one or more fixed groups of registers.

2. The method of claim 1, further comprising:
receiving, from a hardware device, a transaction attempting to access the group of registers; and
comparing information associated with the transaction to a set of criteria associated with an access control patch device, wherein the access control patch device applies the first set of access control rules to the group of registers when at least some of the information associated with the transaction matches the set of criteria.

3. The method of claim 2, wherein the information associated with the transaction includes at least one address that corresponds to one of the plurality of registers and the set of criteria includes one or more addresses that correspond to registers in the group of registers.

4. The method of claim 2, wherein the first set of access control rules includes an attribute of at least one hardware device that is permitted to access the group of registers.

5. The method of claim 4, wherein the information associated with the transaction includes an attribute of a hardware device that initiated the transaction.

6. The method of claim 1, further comprising:
obtaining a patch configuration that includes at least one address of a register in the plurality of registers and the first set of access control rules, wherein the group of registers is defined based on the at least one address.

7. The method of claim 2, further comprising:
allowing or denying the transaction attempting to access the group of registers based on the first set of access control rules.

8. The method of claim 1, wherein at least one of the first set of access control rules applied to the group of registers is different from the second set of access control rules applied to the one or more fixed groups of registers.

9. An apparatus, comprising:
a patch device including a processing circuit configured to
define a group of registers that includes at least one of a plurality of registers in an integrated circuit, wherein each of the plurality of registers in the integrated circuit has been constrained to one of a plurality of fixed groups of registers; and
apply a first set of access control rules to the group of registers, the first set of access control rules configured to override any of a second set of access control rules applied to the one or more fixed groups of registers.

10. The apparatus of claim 9, wherein the processing circuit is further configured to:
receive, from a hardware device, a transaction attempting to access the group of registers; and
compare information associated with the transaction to a set of criteria associated with an access control patch device, wherein the access control patch device applies the first set of access control rules to the group of registers when at least some of the information associated with the transaction matches the set of criteria.

11. The apparatus of claim 10, wherein the information associated with the transaction includes at least one address that corresponds to one of the plurality of registers and the set of criteria includes one or more addresses that correspond to registers in the group of registers.

12. The apparatus of claim 10, wherein the first set of access control rules includes an attribute of at least one hardware device that is permitted to access the group of registers.

13. The apparatus of claim 12, wherein the information associated with the transaction includes an attribute of a hardware device that initiated the transaction.

14. The apparatus of claim 9, wherein the processing circuit is further configured to:
obtain a patch configuration that includes at least one address of a register in the plurality of registers and the first set of access control rules, wherein the group of registers is defined based on the at least one address.

15. The apparatus of claim 10, wherein the processing circuit is further configured to:
allow or deny the transaction attempting to access the group of registers based on the first set of access control rules.

16. The apparatus of claim 9, wherein at least one of the first set of access control rules applied to the group of registers is different from the second set of access control rules applied to the one or more fixed groups of registers.

17. A apparatus comprising:
means for defining a group of registers that includes at least one of a plurality of registers in an integrated circuit, wherein each of the plurality of registers in the integrated circuit has been constrained to one of a plurality of fixed groups of registers; and
means for applying a first set of access control rules to the group of registers, the first set of access control rules configured to override any of a second set of access control rules applied to the one or more fixed groups of registers.

18. The apparatus of claim 17, further comprising:
means for receiving, from a hardware device, a transaction attempting to access the group of registers; and
means for comparing information associated with the transaction to a set of criteria associated with an access control patch device, wherein the access control patch device applies the first set of access control rules to the group of registers when at least some of the information associated with the transaction matches the set of criteria.

19. The apparatus of claim 18, wherein the information associated with the transaction includes at least one address that corresponds to one of the plurality of registers and the set of criteria includes one or more addresses that correspond to registers in the group of registers.

20. The apparatus of claim 18, wherein the first set of access control rules includes an attribute of at least one hardware device that is permitted to access the group of registers.

21. The apparatus of claim 20, wherein the information associated with the transaction includes an attribute of a hardware device that initiated the transaction.

22. The apparatus of claim 17, further comprising:
means for obtaining a patch configuration that includes at least one address of a register in the plurality of registers and the first set of access control rules, wherein the group of registers is defined based on the at least one address.

23. The apparatus of claim 18, further comprising:
means for allowing or denying the transaction attempting to access the group of registers based on the first set of access control rules.

24. The apparatus of claim 17, wherein at least one of the first set of access control rules applied to the group of registers is different from the second set of access control rules applied to the one or more fixed groups of registers.

25. A non-transitory processor-readable storage medium having instructions stored thereon, which when executed by at least one processing circuit causes the at least one processing circuit to:
define a group of registers that includes at least one of a plurality of registers in an integrated circuit, wherein each of the plurality of registers in the integrated circuit has been constrained to one of a plurality of fixed groups of registers; and
apply a first set of access control rules to the group of registers, the first set of access control rules configured to override any of a second set of access control rules applied to the one or more fixed groups of registers.

26. The non-transitory processor-readable storage medium of claim 25, wherein instructions further cause the at least one processing circuit to:
receive, from a hardware device, a transaction attempting to access the group of registers; and
compare information associated with the transaction to a set of criteria associated with an access control patch device, wherein the access control patch device applies the first set of access control rules to the group of registers when at least some of the information associated with the transaction matches the set of criteria.

27. The non-transitory processor-readable storage medium of claim 26, wherein the information associated with the transaction includes at least one address that corresponds to one of the plurality of registers and the set of criteria includes one or more addresses that correspond to registers in the group of registers.

28. The non-transitory processor-readable storage medium of claim 26, wherein the information associated with the transaction includes an attribute of a hardware device that initiated the transaction.

29. The non-transitory processor-readable storage medium of claim 25, wherein the instructions further cause the at least one processing circuit to:
obtain a patch configuration that includes at least one address of a register in the plurality of registers and the first set of access control rules, wherein the group of registers is defined based on the at least one address.

30. The non-transitory processor-readable storage medium of claim 26, wherein the instructions further cause the at least one processing circuit to:
allow or deny the transaction attempting to access the group of registers based on the first set of access control rules.
